(19) United States
(12) Patent Application Publication
(10) Pub. No.: US 2007/0059098 A1
(43) Pub. Date: Mar. 15, 2007

(54) Automatic ground marking method and apparatus

(76) Inventors: Ian Mayfield, Oxford (AU); Matthew Johnson, Beenleigh (AU)

Correspondence Address: SMITH, GAMBRELL & RUSSELL, SUITE 3100, PROMENADE II, 1230 PEACHTREE STREET, N.E., ATLANTA, GA, 30307-3592, US

(21) Appl. No.: 11/407,866

(22) Filed: Apr. 18, 2006

Related U.S. Application Data
(63) Continuation-in-part of application No. 10/669,555, filed on Sep. 25, 2003, now Pat. No. 7,029,199.
Application No. 10/669,555 is a continuation of application No. PCT/AU02/00357, filed on Mar. 25, 2002.

(51) Int. Cl. E01C 23/07

(52) U.S. Cl. 404/84.5

(57) ABSTRACT

An automatic ground marking apparatus including a carriage (1) responsive to carriage control signals for traversing the ground (5), the carriage having a controllable steering and drive system, a controllable marking system and a position determining system (6) arranged to determine the position of the carriage. The ground marking apparatus further includes a processor (8) responsive to the position determining system and operatively executing a software product for generating said carriage control signals to cause the carriage (1) to mark out a predetermined sign (14) on the ground.

### CROSS-REFERENCE TO RELATED APPLICATION

This application is a continuation-in-part of copending U.S. utility application entitled, “AUTOMATIC GROUND MARKING METHOD AND APPARATUS,” having Ser. No. 10/669,555, filed Sep. 25, 2003, and PCT application entitled, “AUTOMATIC GROUND MARKING METHOD AND APPARATUS” having appl. no. PCT/AU02/00357, filed Mar. 25, 2002, both of which are incorporated herein by reference in their entirely.

### TECHNICAL FIELD

The present invention relates to an apparatus and method for making markings on ground surfaces such as turf playing fields and fairways. The invention has particular although not exclusive application where there is a need to automatically produce signs, such as logos or advertisements for example, on large ground surfaces whether even, sloped or undulating.

### BACKGROUND OF THE INVENTION

A variety of arrangements for marking turf, such as the turf of playing fields, are known in the prior art. The simplest turf marking involves the application of straight lines to demarcate playing field boundaries. Commercially available line marking machines are used to facilitate such marking. Such machines may include a line of sight guide to aid the operator in producing a straight line between two reference points. Line marking machines are not suitable for producing complex signs or logos on turf.

Over the last two decades there has been a trend to mark playing fields with signs such as corporate logos or advertisements. High profile sporting events attract large crowds and television coverage so that turf advertisements are effective as such events are viewed by a large audience.

One way in which signs have traditionally been produced on turf has been with the help of stencils having apertures through which paint is sprayed or otherwise applied. The production and application of stencils for creating complex and large turf markings is time consuming and prone to error.

The surface of grounds such as sporting fields typically include variations in surface level, such as for drainage purposes. These variations can vary from tens of centimeters and upwards across conventional sporting fields. Large variations or undulations can cause distortion of logos and possibly affect viewing by spectators. On a golf course there are deliberate variations and undulations in ground surfaces, which exacerbate problems with application and viewing of ground markings.

Hitherto it has not been widely known to automatically apply complex markings to ground surfaces, especially to turf which is non-planar, undulating or uneven, since neither of the previously discussed approaches to the generation of turf markings are particularly suited to application on a non-planar or sloping surface.

### SUMMARY OF THE INVENTION

Embodiments of the present invention provide a method and apparatus for marking ground surfaces with graphics such as corporate logos.

Briefly described, in architecture, one embodiment of the system, among others, can be implemented as follows. An automatic ground marking apparatus including a carriage responsive to carriage control signals for traversing the ground, the carriage having a controllable steering and drive system, a controllable marking system and a position determining system arranged to determine the position of the carriage. The ground marking apparatus further includes a processor responsive to the position determining system and operatively executing a software product for generating said carriage control signals to cause the carriage to mark out a predetermined sign on the ground.

The present invention can also be viewed as providing methods for marking undulating turf. In this regard, one embodiment of such a method, among others, can be broadly summarized by the following steps: (1) monitoring the position of an automated carriage arranged to move over a predetermined path; (2) creating a collection of points defining a desired sign using recorded position coordinates; and (3) processing the collection of points to generate control signals to cause the carriage to traverse the ground in the predetermined path to mark out the desired sign.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 depicts an automated turf-marking carriage according to one embodiment of the present invention.

FIG. 2 is a top plan view of the layout of the carriage of FIG. 1 with top cover removed.

FIG. 3 is a rear elevational view of the carriage of FIG. 2.

FIG. 4A is a flow chart of the steps implemented by a software product used in an embodiment of the present invention.

FIG. 4B is a flow chart of the steps implemented in the creation of the map coordinates using map coordinates generation process 40 in an embodiment of the present invention.

FIG. 4C is a flow chart of steps implemented the adjusted graphic perspective software used by the software product in an embodiment of the present invention.

FIG. 4D is a flow chart of steps implemented the adjusted graphic for surface distortion software used by the software product in an embodiment of the present invention.

FIG. 4E is a flow chart of the steps implemented the adjust graphic for horizontal surface distortion software used by the software product in an embodiment of the present invention.

FIG. 5 is a flow chart showing the flow of data through the system of FIG.

FIG. 6 depicts an automated turf-marking carriage according to a further embodiment of the present invention.

FIG. 7 depicts an undulating turfed surface upon which a sign has been marked.

### DETAILED DESCRIPTION OF THE PREFERRED EMBODIMENT

According to a first aspect of the invention there is provided an automatic ground marking apparatus including: a carriage responsive to carriage control signals for traversing the ground, the carriage having a controllable steering and drive system and a controllable marking system; a position determining system arranged to determine the position of the carriage; and a processor responsive to the position determining system and operatively executing a software product for generating said carriage control signals wherein the controllable steering and drive system respond to said carriage control signals to cause the carriage to traverse the ground and mark out a predetermined sign on the ground.

In the present specification, the term “position” includes position of an object in three dimensional (3D) space, including the latitude, longitude and height of the object relative to a predetermined point of reference. If required, the carriage control signals are transmitted to the carriage from a remote processor, which processor is associated with points defining the predetermined sign.

Preferably the position determining system comprises a laser based electronic distance measuring system including a base station and a reflector.

In one embodiment the base station is mounted to the carriage. In this embodiment the processor is also mounted to the carriage and connected to receive position data from the base station. In an alternative embodiment the base station is fixed to the ground and the reflector is mounted to the carriage.

In that event the processor is connected to receive position data from the base station, the marking system further including a radio link to relay carriage control signals to the carriage. This radio link includes, but is not limited to: Bluetooth, WiFi, cellular, optical, satellite, RF, Ethernet, LAN, WAN, magnetic induction, coax, RS-485, INCOM, SCADA or the like.

The controllable steering and drive system may incorporate an on-board compass with further processing apparatus responsive to the compass and arranged to determine an actual bearing of the carriage.

Preferably the further processing apparatus compares the actual bearing with a desired bearing encoded in the guidance signals transmitted. The desired bearing is typically generated by the carriage guidance system. As an alternative to the laser based electronic distance measuring system, the carriage guidance system may instead include a GPS receiver for a GPS distance measuring system.

Preferably the controllable marking system includes a reservoir for a marking medium, such as paint, and a dispensing nozzle. A controllable valve may interconnect the reservoir and dispensing nozzle.

The controllable steering and drive system may include a number of independently controllable drive units each coupled to a corresponding wheel of the carriage. The carriage may further include a feedback sensor arranged to provide a feedback signal to the processor. The feedback sensor may be a shaft encoder, an inclinometer or a compass.

Where the processor is located external of the carriage, a convenient way in which the feedback signal may be relayed to the processor is by means of a radio link. This radio link includes, but is not limited to: Bluetooth, WiFi, cellular, optical, satellite, RF, Ethernet, LAN, WAN, magnetic induction, coax, RS-485, INCOM, SCADA or the like.

According to a further aspect of the present invention there is provided a computer software product stored on a computer readable memory and executable by a processor for causing a carriage including a controllable steering and drive system and a controllable marking system to mark out a sign the software product including: carriage position instructions for reading a carriage position from a data stream generated by a position sensing device; sign point instructions for reading a file of points defining a predetermined sign; command instructions for generating commands to cause a carriage to traverse the ground surface and dispense paint on the surface in order to mark out said sign.

In another aspect of the present invention there is provided a method for surveying an area by means of an automated carriage arranged to move over a predetermined path, the method comprising the steps of: initiating movement of the carriage over the path; monitoring the position of the carriage; and recording position coordinates of the carriage in a computer file.

Preferably the step of monitoring the position of the carriage is achieved by means of an EDM system at a remote site, wherein a reflective portion of said system is mounted on the carriage and wherein the base station of the EDM system is at least part of the remote site. Alternatively, the EDM system may be on-board the carriage and arranged for interaction with remote reflectors.

In that event the processor is connected to receive position data from the base station, the marking system further including a radio link to relay carriage control signals to the carriage. This radio link includes, but is not limited to: Bluetooth, WiFi, cellular, optical, satellite, RF, Ethernet, LAN, WAN, magnetic induction, coax, RS-485, INCOM, SCADA or the like.

The controllable steering and drive system may incorporate an on-board compass with further processing apparatus responsive to the compass and arranged to determine an actual bearing of the carriage.

Preferably, the further processing apparatus compares the actual bearing with a desired bearing encoded in the guidance signals transmitted. The desired bearing is typically generated by the carriage guidance system.

As an alternative to the laser based electronic distance measuring system, the carriage guidance system may instead include a GPS distance measuring system.

Preferably the controllable marking system includes a reservoir for a marking medium, such as paint, and a dispensing nozzle. A controllable valve may interconnect the reservoir and dispensing nozzle.

The controllable steering and drive system may include a number of independently controllable drive units each coupled to a corresponding wheel of the carriage. The carriage may further include a feedback sensor arranged to provide a feedback signal to the processor. The feedback sensor may be a shaft encoder, an inclinometer or a compass. Where the processor is located external of the carriage, a convenient way in which the feedback signal may be relayed to the processor is by means of a radio link. This radio link includes, but is not limited to: Bluetooth, WiFi, cellular, optical, satellite, RF, Ethernet, LAN, WAN, magnetic induction, coax, RS-485, INCOM, SCADA or the like.

According to a further aspect of the present invention there is provided a computer software product stored on a computer readable memory and executable by a processor for causing a carriage including a controllable steering and drive system and a controllable marking system to mark out a sign the software product including: carriage position instructions for reading a carriage position from a data stream generated by a position sensing device; sign point instructions for reading a file of points defining a predetermined sign; command instructions for generating commands to cause a carriage to traverse the ground surface and dispense paint on the surface in order to mark out said sign.

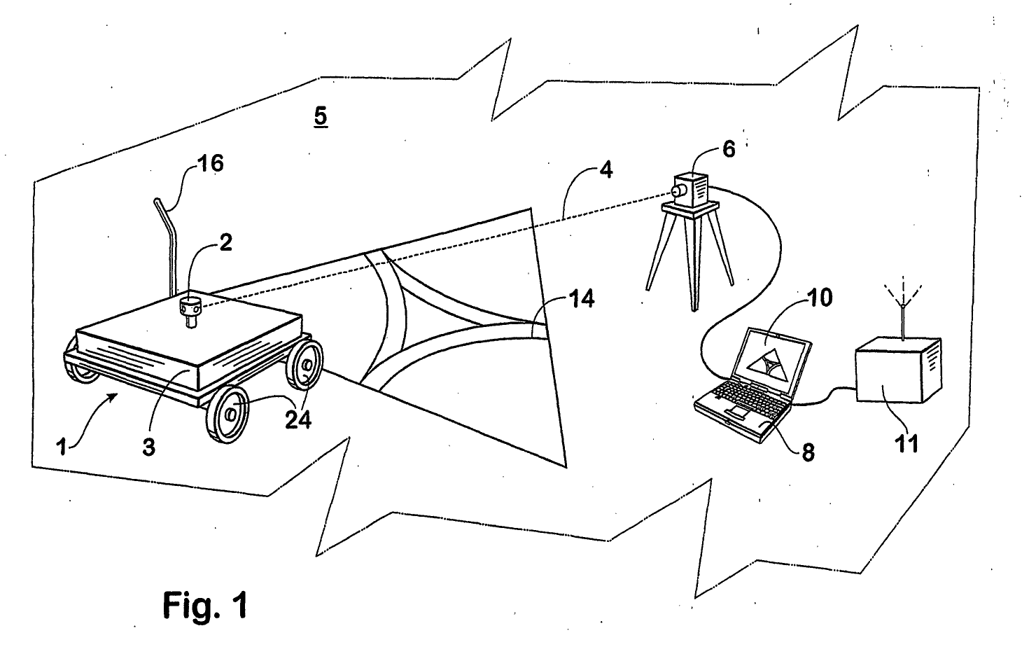

A preferred embodiment of an automatic turf marking system of the invention will be described in overview with reference to FIG. 1. A maneuverable paint dispensing carriage 1 for traversing the ground 5 includes a reflective tracking prism 2. A cover 3 covers the internal components of the carriage. An electronic distance measuring (EDM) base station 6 tracks the location of the carriage 1 by reflecting a laser beam 4 off the tracking prism. The base station 6 and prism 2 may be obtained as components of an AP-11A auto-tracking electronic distance measuring system available from Topcon America Corporation of 37 West Century Road, Paramus, N.J. 07652, USA.

A PDA (personal digital assistant) 8 is coupled to a digital position data port on the base station 6. A handheld computer, laptop, PDA, Pocket PC, palm devices, tablets or other like device may be used in place of the PDA 8. Generally, in terms of hardware architecture, as shown in FIG. 1, the PDA 8 includes a processor, memory, and one or more input and/or output (I/O) devices (or peripherals) that are communicatively coupled via a local interface. The local interface can be, for example but not limited to, one or more buses or other wired or wireless connections, as is known in the art. The local interface may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor is a hardware device for executing software, particularly that stored in memory. The processor can be any custom made or commercially available processor, a central processing unit (CPU), an auxiliary processor among several processors associated with the computer, a semiconductor based microprocessor (in the form of a microchip or chip set), a macroprocessor, or generally any device for executing software instructions. Examples of suitable commercially available microprocessors are as follows: a PA-RISC series microprocessor from Hewlett-Packard Company; an 80x86, Itanium or Pentium series microprocessor from Intel Corporation; a PowerPC microprocessor from IBM; a Sparc microprocessor from Sun Microsystems, Inc; or a 68xxx series microprocessor from Motorola Corporation.

The memory can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory may incorporate electronic, magnetic, optical, and/or other types of storage media. Note that the memory can have a distributed architecture, where various components are situated remote from one another, but can be accessed by the processor.

The software in memory may include one or more separate programs, each of which comprises an ordered listing of executable instructions for implementing logical functions. The software in the memory includes the automatic turf marking system in accordance with the present invention and a suitable operating system (O/S). A nonexhaustive list of examples of suitable commercially available operating systems is as follows: (a) a Windows operating system available from Microsoft Corporation; (b) a Netware operating system available from Novell, Inc.; (c) a Macintosh operating system available from Apple Computer, Inc.; (e) a UNIX operating system, which is available for purchase from many vendors, such as the Hewlett-Packard Company, Sun Microsystems, Inc., and AT&T Corporation; (d) a LINUX operating system, which is freeware that is readily available on the Internet; (e) a run time Vxworks operating system from WindRiver Systems, Inc.; or (f) an appliance-based operating system, such as that implemented in handheld computers or personal data assistants (PDAs) (e.g., Symbian OS available from Symbian, Inc., PalmOS available from Palm Computing, Inc., and Windows CE available from Microsoft Corporation). The operating system essentially controls the execution of other computer programs, such as the automatic turf marking system, and provides scheduling, input-output control, file and data management, memory management, and communication control and related services.

The I/O devices may include input devices, for example but not limited to, a keyboard, mouse, scanner, microphone, etc. Furthermore, the I/O devices may also include output devices, for example but not limited to, a printer, display, etc. Finally, the I/O devices may further include devices that communicate both inputs and outputs, for instance but not limited to, a modulator/demodulator (modem; for accessing another device, system, or network), a radio frequency (RF) or other transceiver, Bluetooth, WiFi, cellular, optical, satellite, Ethernet, LAN, WAN, magnetic induction, coax, RS-485, INCOM, SCADA or the like.

The PDA 8 may further include a basic input output system (BIOS) (omitted for simplicity). The BIOS is a set of essential software routines that initialize and test hardware at startup, start the O/S, and support the transfer of data among the hardware devices. The BIOS is stored in ROM so that the BIOS can be executed when the PDA 8 is activated.

As will be explained, the PDA 8 includes a processor that executes a software product that compares position data from the base station with a pre-stored data file. The data file contains coordinate points defining a desired sign or logo to be applied to the turf. The software product may be configured to cause the PDA 8 to display the desired logo on a display screen 10. Under control of the software product, the processor generates a series of steering and paint dispensing instructions that are output to a radio transmitter 11. The radio transmitter 11 transmits corresponding radio control signals to the carriage 1 for reception by an antenna 16. The carriage receives the radio control signals and moves and releases paint in accordance with the control signals in order to mark out turf logo 14.

It is not necessary for the entire turf logo to be marked out by carriage 1. For example the software program may be configured so that the carriage marks out a number of points sufficient for a manual operator to complete the turf logo by hand. In the presently described embodiment, the EDM base station 6, processor (in the form of the PDA 8) and transmitter form a carriage guidance or position determining system. Although the EDM base station is coupled to the lap-top computer 10 by a cable link in the drawings, it will be appreciated that the base station may be remotely controlled using radio link therebetween, such as, for example, but not limited to a Bluetooth, WiFi, cellular, optical, satellite, RF, Ethernet, LAN, WAN, magnetic induction, coax, RS-485, INCOM, SCADA or the like.

When the PDA 8 is in operation, the processor is configured to execute software stored within the memory, to communicate data to and from the memory, and to generally control operations of the PDA 8 pursuant to the software. The automatic turf marking system and the O/S, in whole or in part, but typically the latter, are read by the processor, perhaps buffered within the processor, and then executed.

The automatic turf marking system, which can comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. When the automatic turf marking system is implemented in software, it should be noted that the automatic turf marking system can be stored on any computer readable medium for use by or in connection with any computer related system or method.

In the context of this document, a computer readable medium is an electronic, magnetic, optical, or other physical device or means that can contain or store a computer program for use by or in connection with a computer related system or method. The automatic turf marking system can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

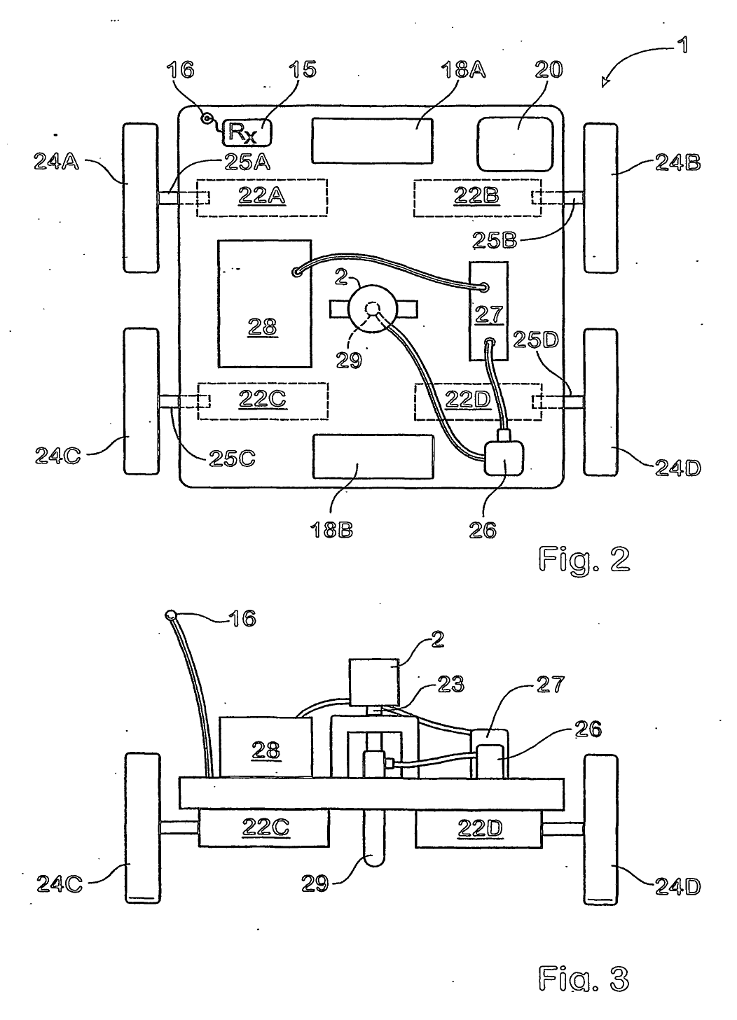

Referring now to FIG. 2 there is depicted a plan view of the module layout of carriage 1 with cover 3 removed. The carriage includes an antenna 16 coupled to a receiver 15 which in turn is coupled to a control module 20. Also included are batteries 18A, 18B which provide power for the receiver 15, the control module 20, drive and steering modules 22A-22D, a pump 27 and a solenoid actuated valve 26.

The control module sends command signals to drive and steering modules 22A-22D each of which are coupled to wheels 24A-24D respectively by axle shafts 25A-25D. As will be explained, shaft encoders may be employed to confirm that the steering and drive command signals are accurately carried out. The control module 20 also sends commands to solenoid actuated valve 26 in order to control the dispensing of paint through nozzle 29 onto turf 5 beneath the carriage 1.

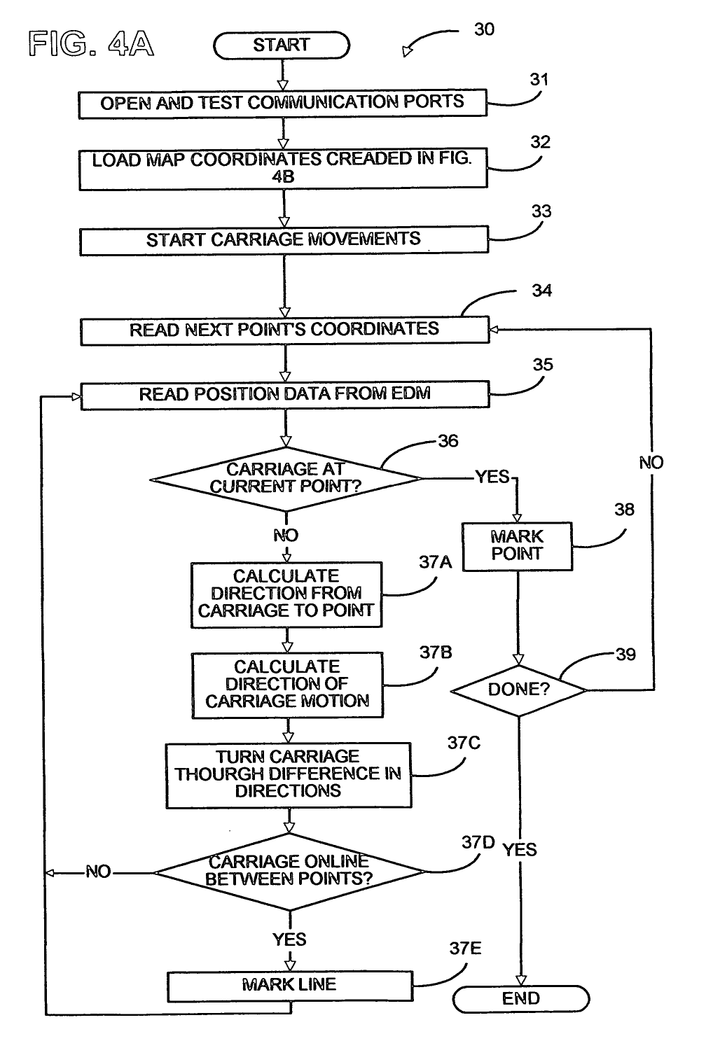

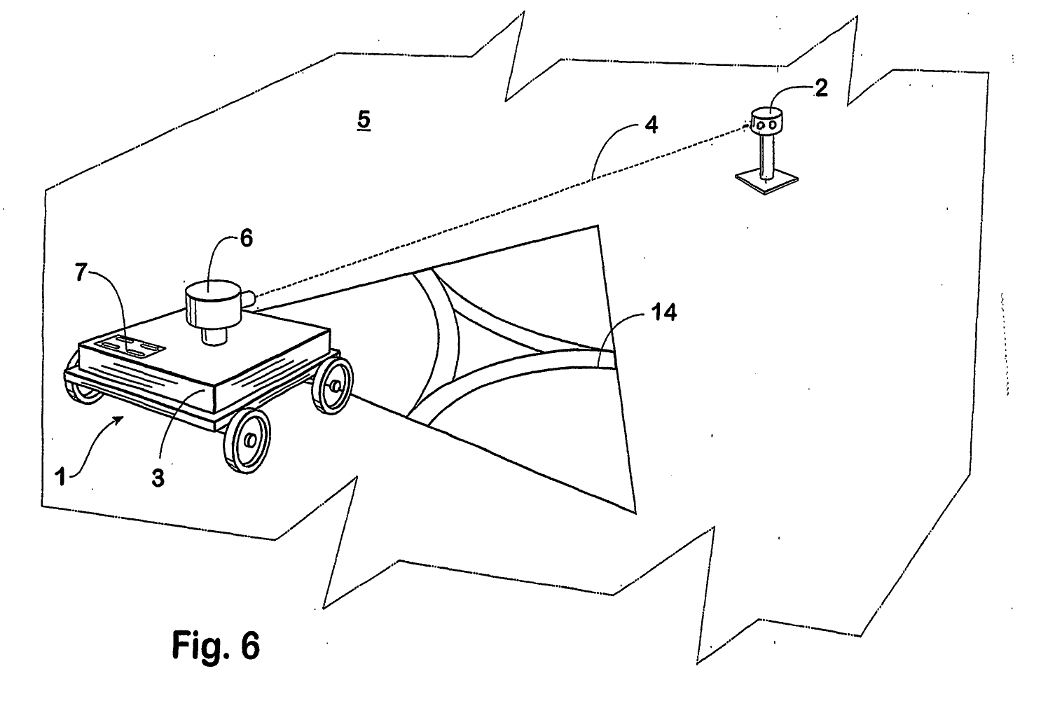

FIG. 3 is a rear view of the carriage of FIG. 2 viewed along arrow A, with battery 18B removed. In another embodiment of the invention, the tracking prism 2 and dispenser nozzle 29 may be mounted on a gimbal structure whereby the prism may be maintained vertically above the nozzle, even when the carriage is required to traverse an inclined surface, such as that illustrated in FIG. 7. This arrangement facilitates use of a taller mast 23 for carrying the tracking prism 2, better suited to operation of the carriage 1 on sloping or undulating surfaces. If required, an inclinometer may be employed on the carriage. The inclinometer may be used either to automatically maintain the mast in a vertical orientation, or to transmit inclination data to the processor for real-time compensation of carriage inclination.

In an alternative embodiment, the automatic turf marking system will receive position data directly from EDM or GPS or any other suitable position establishing system and process the data on board.

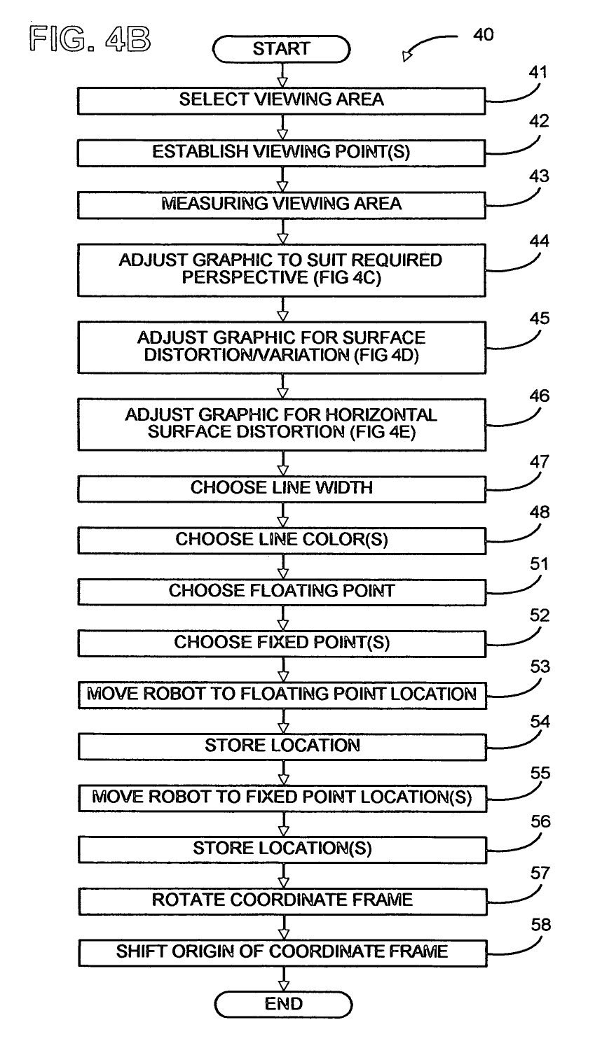

Referring now to FIG. 4A, there is depicted a flow chart of a process 30 coded into the software product executed by the processor of PDA 8 in FIG. 1. The software product for the automatic turf marking system is a source program, executable program (object code), script, or any other entity comprising a set of instructions to be performed. When a source program, then the program needs to be translated via a compiler, assembler, interpreter, or the like, which may or may not be included within the memory, so as to operate properly in connection with the O/S.

Furthermore, the automatic turf marking system 30 can be written as (a) an object oriented programming language, which has classes of data and methods, or (b) a procedure programming language, which has routines, subroutines, and/or functions, for example but not limited to, C, C++, Pascal, Basic, Fortran, Cobol, Perl, Java, and Ada. The software product contains instructions to implement each of the steps of FIG. 4A of the procedure that will now be described. It will be realized that the actual coding of the instructions is straightforward for persons skilled in this field, once the functionality of the software product is explained.

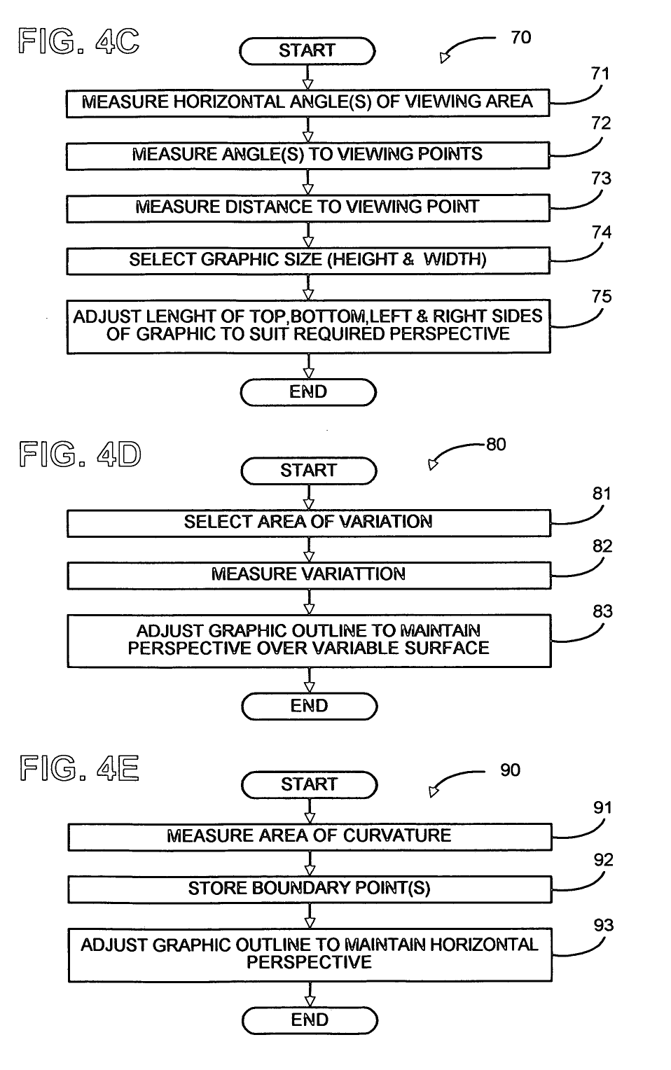

At step 31 the communication ports used by PDA 8 to communicate with base station 6 and radio transmitter 11 are opened and tested. At the step 32, the map coordinates are loaded. Map coordinates are generated utilizing a map coordinates generation process as herein defmed in further detail with regard to FIG. 4B. The map coordinates generation process generates the “map” file 9 (see FIG. 5) containing point coordinates defining the graphic to be demarcated by carriage 1 is opened.

At step 33 a command to start the carriage moving forward is generated. The command is sent to transmitter 11 which in turn converts it to a radio frequency control signal that is transmitted to carriage 1. The carriage receives the signal by means of antenna 16, generates a corresponding baseband signal by means of receiver 15 and passes the baseband signal to control electronics module 20. The control module generates corresponding commands that are sent to drive modules 22A-22D in order to start the carriage moving forwards.

At step 34 the computer reads the next point from the map file and sets it to be the current point for processing. At step 35 the computer reads carriage position data from base station 6. At step 36 the PDA 8 compares the data read at step 34 with the data read at step 35. If the two points are not within a small distance of each other then the PDA 8 decides that the carriage is not at the point dictated by the map coordinate. Consequently, at step 37A the direction vector from the carriage to the desired map coordinate is calculated.

At step 37B the velocity vector of the carriage is calculated. At step 37C, the difference between the direction vector and the velocity vector is determined in order to generate a turn command to turn the carriage so that it heads towards the map point. At step 37D, it is determined if the carriage is online between points. If the carriage is online between points the mark line command is generated causing a paint spray to be dispensed through nozzle 29. If within a specified tolerance of this line, which is preset by the user, (i.e. ¼ of an inch (4 mm)) it will active the spray at a preset frequency to form a continuous line.

However, if it is determined at step 37D that the carriage is not online between points or after marking the line at step 37E, the control then diverts to step 35 and steps 35-37E are repeated until it is determined at decision point 36 that the carriage and the current map point are sufficiently close enough for it to be said that the carriage is at the current map point.

However, if it is determined that step 36 that the carriage is at or sufficiently close to a current point, then control diverts to step 38. At step 38 a mark command is generated causing a paint spray to be dispensed through nozzle 29.

At decision point 39, the PDA 8 checks if the current point of the map file is the last point in the file. In the event that it is the last point then the procedure ends. Alternatively, control passes back to step 34 and the previous procedure is repeated until all the points of the map file have been processed.

FIG. 4B is a flow chart of the steps implemented in the creation of the map coordinates using map coordinates generation process 40 in an embodiment of the present invention. This process is completed by the user to set up the map, prior to starting the robot.

First, the viewing area is selected at step 41. At step 42 the viewing points for the viewing area are established. Viewing area is the area where the graphic will be placed on the turf or surface. The viewing point in the area from where at the graphic is to be viewed from and the viewing points are chosen by the operator.

At step 44, the graphic is adjusted to suit the require perspective. The process involved in adjusting the logo to suit the require perspective is herein defined further detail with regard to FIG. 4C. In summary the graphic is adjusted to maintain its original perspective by eliminating viewing distortions caused by placing the graphic on the ground. Examples include placing a graphic on a golf fairway facing towards players and an audience on and around the golf tee.

The user can input the positions of the viewing area and viewing point(s) and the software will calculate horizontal angle of the viewing area, the horizontal angle to the viewing point and the distance to the viewing point or points in the software. It will then adjust the perspective of the ground graphic in order to maintain the original viewing perspective.

Next at step 45, the graphic is adjusted for surface distortion or variation. The steps involved adjusting the graphic for surface distortion or variation is herein defined in further detail with regard to FIG. 4D. In summary, the graphic is adjusted for surface distortion, by taking into account any hills, rises, falls, holes or other terrain variations that could affect the perception of the graphic.

At step 46, the graphic is adjusted for horizontal surface distortion or level perspective. The steps involved to adjust the graphic for horizontal distortion, are herein defined in further detail with regard to FIG. 4E. In summary, the graphic is adjusted to allow for any curvature of slope in the viewing area away from the viewing position. This is adjusted to maintain a level perspective of the graphic with the horizon. An example would be when a graphic is placed on the slope on the front of a round tee. The graphic needs to be adjusted to follow the slope around the curve to maintain a level appearance.

At step 47, the line width of the outline for the graphic is chosen. At step 48, the line color or colors are selected. In the preferred embodiment, the line width and colors are selected by a user. However, if just the outlined of the graphic is being illustrated, a default colors such as black can be utilized.

Next, the floating-point and fixed point are selected at steps 51 and 52 respectively. Generally, fixed points are start points on a line or curve for the graphic being illustrated. Floating points indicate the direction the graphic will face. For example, the procedure when orientating a graphic is to choose a fixed point which is an exact position of a specific point of the graphic. If we choose the centre line bottom point as a fixed point this will be where the bottom of the graphic is positioned. If we then choose the centre line top point as the bearing point and position this to be directly pointed at the viewing point this will set the angle of the graphic towards the viewing point.

In an alternative embodiment, the floating-point can be used as a second fixed point, which will then determine the actual height or width of the graphic. And one alternative embodiment, by determining the actual height or width of the graphic, it is transferred to the dimension not selected. In still another embodiment, the actual height and width of the graphic can be determined independently of the other dimension by the use of multiple fixed points. Three is the minimum number of fixed points needed to independently define the height and width of the graphic.

At step 53, the robot is moved to a floating-point location in that location is stored at step 54. At step 55, the robot is moved to a fixed point location and that location is stored at step 56. If there is more than one fixed point, step 55 is repeated at least once and steps 53 and 54 are skipped.

At step 57, the coordinate frame is rotated to reflect the proper perspective view. At step 58, the coordinate flame is shifted from the origin. Rotate coordinate frame refers to after the software has accepted the floating and fixed point it will then orient the graphic on the map to match these coordinates. For example, the points described above on the centre line of the graphic may be points 1 and 2 on line 1 of the graphic. These are now matched to suit the actual coordinates of the map thus rotating the coordinate flame.

After the coordinate frame is shifted to reflect the origin, the map coordinate software 40 exits.

FIG. 4C is a flow chart of steps implemented the adjusted graphic perspective software 70 used by the software product 30 in an embodiment of the present invention. In summary the graphic is adjusted to maintain its original perspective by eliminating viewing distortions caused by placing the graphic on the ground. Examples include placing a graphic on a golf fairway facing towards players and an audience on and around the golf tee.

First, the horizontal angles of the viewing area are measured at step 71. This measurement may be obtained programmatically from the area selected at step 41 (FIG. 4 B). At steps 72 and 73 respectively, the angles and distance to the viewing points established at steps 51 and 52 are measured.

At step 74, the size of the graphic is selected. In the preferred embodiment, the logo or graphic size (i.e. height and weight) can be determined by the user of the ground marking apparatus. In the alternative embodiments. It is contemplated that the logo or graphic size can be programmatically determined by the viewing area selected. In the program programmatic selection, the user can indicate that the logo or graphic area should be maximized.

At step at 75, the top, bottom, left and right side of the logo or graft is adjusted to suit the indicated perspective. After adjusting be logo or graph to the require perspective then the adjusted graphic perspective software 70 exits.

FIG. 4D is a flow chart of steps implemented the adjusted graphic for surface distortion software 80 used by the software product 30 in an embodiment of the present invention. In summary, the graphic is adjusted for surface distortion, by taking into account any hills, rises, falls, holes or other terrain variations that could affect the perception of the graphic. If for example a logo needs to be placed over some rising and falling area. The area can be measured xyz, the logo is then draped over the coordinates on the map to match the variations of the surface and to produce an even perspective on an undulating surface.

In the first at step 81, the area of variation is selected. At step 82, the selected area of variation is measured.

At step 83, the graphic outlined is adjusted to maintain perspective over a variable surface. This adjustment is done programmatically in order to take into account any hills, rises, falls, holes or other terrain variations that could affect the perception that the graphic. After adjusting the graphic outlined to maintain perspective, the adjusted graphic for surface distortion software 80 exits.

FIG. 4E is a flow chart of the steps implemented the adjust graphic for horizontal surface distortion software used by the software product in an embodiment of the present invention. In summary, the graphic is adjusted to allow for any curvature of slope in the viewing area away from the viewing position. This is adjusted to maintain a level perspective of the graphic with the horizon. An example would be when a logo is placed on the slope on the front of a round tee. The logo needs to be adjusted to follow the slope around the curve to maintain a level appearance.

The first, the area the curvature is measured at step 91. At step 92, the boundary points of the area of curvature are stored in memory. At step 93, the logo or graphic outlined is adjusted to maintain the horizontal perspective. An example would be when a logo is placed on the slope on the front of a round tee. The logo need to be adjusted to follow the slope around the curve to maintain a level appearance.

The flow charts of FIG. 4A through 4E show the architecture, functionality, and operation of a possible implementation of the software product. In this regard, each block represents a module, segment, or portion of code, which comprises one or more executable instructions for implementing the specified logical function(s). It should also be noted that in some alternative implementations, the functions noted in the blocks may occur out of the order noted in the figures. For example, two blocks (i.e. 37A and 37B) shown in succession in FIG. 4A may in fact be executed substantially concurrently or the blocks may sometimes be executed in the reverse order, depending upon the functionality involved.

The automatic turf marking system of the present invention can be implemented in hardware, software, firmware, or a combination thereof. In the preferred embodiment(s), the automatic turf marking system is implemented in software or firmware that is stored in a memory and that is executed by a suitable instruction execution system.

In an alternative embodiment, the automatic turf marking system can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

With reference to FIG. 5 there is shown a block diagram of many of the components of the previously described system showing the flow of information enabling positioning of the carriage and dispensing of paint as previously described.

Apart from turf marking, the carriage 1 may also be used as a surveying tool in which mode it is run back and forth over a surface to be surveyed. The procedure is suitably as follows:

Initially a path is defmed for the carriage to follow. The path may be defined in the same way as setting a path for marking. Normally the path will consist of parallel evenly spaced lines covering the surface in question. The carriage is then set up and commanded to follow the path.

Each time the EDM equipment sends distance data to the computer it will also send the level or height of the carriage (Z coordinate) data. These levels or heights are stored in a file along with the corresponding latitude (X coordinate) and longitude (Y coordinate) position data.

The result is a data file defining a grid or points covering the area of interest that may be up-loaded to a computer-aided design (CAD) package for use in creating a digital terrain model (DTM). It will be appreciated that this survey procedure may be conveniently employed to create a DTM for the region of a surface desired to be marked.

Although not essential to operation, feedback sensors such as shaft encoders, a compass and/or an inclinometer may be included on the carriage 1. Data from the feed back sensors may be transmitted back to PDA 8 by means of an additional radio frequency (RF) link. The software program may contain instructions to process the received feedback data in order to modify the control signals transmitted thereby implementing a feedback control loop in order to minimise divergence of the carriage's path from the map coordinates.

Where an on-board computer is incorporated, the carriage guidance system may be arranged to transmit a desired direction bearing to the carriage. A processor on the carriage calculates the carriage's actual bearing as sensed by the compass and compares it to the desired bearing in order to generate commands to steer the carriage along the desired bearing. The carriage guidance system also sends the carriage signals to control speed and to dispense paint. Accordingly in this embodiment two separate computer programs work together.

While the invention has been described as making use of an electronic distance measuring apparatus in the form of a laser base station, it is possible to use other apparatus for determining the position of the carriage. For example, a global positioning system (GPS) receiver might be used, together with differential correction as required. However, GPS data is typically limited to 20 mm accuracy; whereas data derived from an EDM system as explained herein, typically achieves a minimum of 10 mm accuracy and tighter tolerances are usually achieved than is the case with GPS.

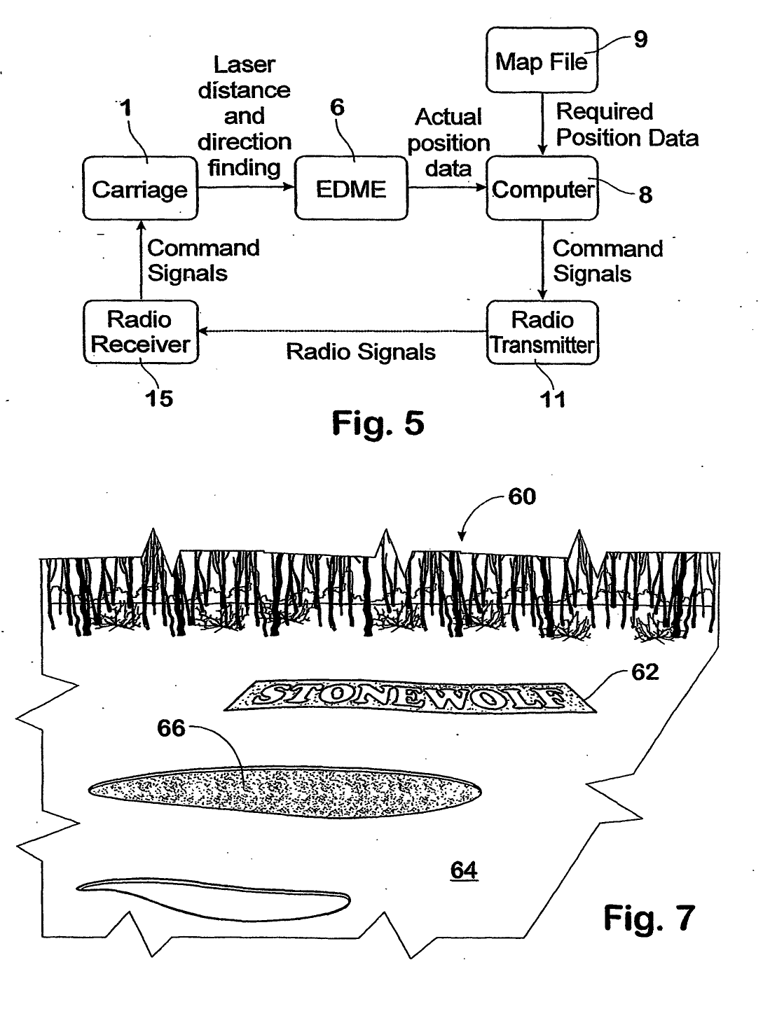

A variation of the embodiment of FIG. 1 will be explained with reference to FIG. 6. In FIG. 6 the EDM base station 6 has been mounted on carriage 1 whereas prism 2 has been fixed in the turf at a predetermined reference position. In this embodiment PDA 8 is incorporated inside carriage 1. The software program executed by the computer is very similar to that explained with reference to FIG. 4 except that it includes instructions to transform the position coordinate data to take into account the transposition of the base station and reflective prism 2. A control panel 7 for entering data into the computer is mounted on cover 3 and is accessible to an operator. In this further embodiment the radio transmitter 11 and radio receiver 14 and antenna 16 are unnecessary, and so are not present. Accordingly, if the further embodiment is employed variations in the height or attitude of the EDM stations must be compensated out. It will be appreciated that use of the marking apparatus on substantially flat ground will obviate the requirement for height data.

In FIG. 7 there is shown a corporate logo “STONEWOLF” 62 applied to the sloping surface of turf 64 in the vicinity of a green 66 on a golf course 60. It is anticipated that points providing an outline of the logo 62 may be automatically produced by a ground marking apparatus according to embodiment of the invention, allowing the negative image of the lettering to be in-filled by hand.

The automatic marking system of the invention allows the creation of logos which take environmental factors into account, including the undulations in the surface to receive the markings and the desired viewing positions for both audiences in attendance and television viewers. Ground slope angles can vary by up to 30%, such as in the case of golf course contours. In such circumstances, prior art methods do not provide a satisfactory result or are otherwise costly, time consuming and laborious.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

1. An automatic ground marking apparatus for marking ground, the apparatus comprising:
a carriage responsive to carriage control signals for traversing the ground, the carriage comprising a controllable steering and drive system and a controllable marking system;
a position determining system arranged to determine the position of the carriage; and
a processor responsive to the position determining system and generating the carriage control signals wherein the controllable steering and drive system respond to the carriage control signals to cause the carriage to traverse the ground and mark out a desired sign on the ground.

2. The automatic ground marking apparatus of claim 1, wherein the carriage control signals are transmitted to the carriage from a remote processor, and wherein the processor associates the carriage control signals with points defining the desired sign.

3. The automatic ground marking apparatus of claim 1, wherein the position determining system further comprises:
a laser based electronic distance measuring device, the laser based electronic distance measuring device further comprising:
a base station; and
a reflector.

4. The automatic ground marking apparatus of claim 1, wherein the marking apparatus further comprises:
a radio link to relay carriage control signals to the carriage from the processor.

5. The automatic ground marking apparatus of claim 1, wherein the controllable steering and drive system further comprises:
a compass; and
a processing device responsive to the compass to determine an actual bearing of the carriage.

6. A computer software product comprising logic stored on computer readable media and executable by a processor for causing a carriage including a controllable steering and drive system and a controllable marking system, to mark out a sign on a ground surface, the software product comprising:
carriage position logic for reading a carriage position from a data stream generated by a position sensing device;
sign point logic for reading a file of points defining a desired sign; and
command logic for generating commands to cause a carriage to traverse the ground surface and dispense paint on the surface in order to mark out the sign.

7. A method for marking undulating turf, comprising the steps of:
monitoring the position of an automated carriage arranged to move over a predetermined path;
creating a collection of points defining a desired sign using recorded position coordinates; and
processing the collection of points to generate control signals to cause the carriage to traverse the ground in the predetermined path to mark out the desired sign.

8. The method of claim 7, wherein the control signals are transmitted to the carriage in real time.

9. The method of claim 7, wherein the step of creating a collection of points further comprises the step of:
determining desired viewing positions for the desired sign.

10. The method of claim 7, wherein the position of the automated carriage is monitored from a remote site.

11. The method of claim 7, wherein the monitored from a position sensing device on-board the carriage.

12. The method of claim 7, further comprising:
initiating movement of the automated carriage over the predetermined path; and recording position coordinates of the automated carriage for producing a digital terrain map.

13. A method of surveying a surface by a carriage adapted to automatically traverse the surface to be surveyed and associated with a position determining system, the method comprising the steps of:
defining a path for the carriage to follow to cover the surface to be surveyed;
generating command signals to instruct the carriage to traverse the path;
receiving positioning data for the carriage from the position determining system during the traverse; and
storing the positioning data in a data file.

14. The method of claim 13, including the subsequent step of creating a digital terrain model (DTM) of the surface from the positioning data.

15. The method of claim 13, wherein the path includes a set of evenly spaced parallel lines and the data file defines a grid of points covering the survey surface.

16. The method of claim 13, wherein the position data comprises carriage level data, carriage latitude data and carriage longitude data.

17. A surveying apparatus for surveying a surface of interest, the surveying apparatus comprising:
a carriage means responsive to carriage control signals for traversing the ground, the carriage having a controllable steering and drive system;
a position determining means arranged to determine the position of the carriage; and
a transmitter means for transmitting the positioning data from the position determining system to a remote station for the creation of a digital terrain model of the surface.

18. The surveying apparatus of claim 17, wherein the positioning data comprises carriage level data, carriage latitude data and carriage longitude data.
